(19) United States
(12) Patent Application Publication
(10) Pub. No.: US 2010/0324873 A1
(43) Pub. Date: Dec. 23, 2010

(54) Method and system for estimating three phase fluid flow for individual wells

(75) Inventor: David Bruce Cameron, Trollasen (NO)

Correspondence Address: CHRISTIAN D. ABEL, ONSAGERS AS, POSTBOKS 6963 ST. OLAVS PLASS, OSLO, N-0130, NO

(73) Assignee: KONGSBERG OIL & GAS TECHNOLOGIES AS, Sandvika (NO)

(21) Appl. No.: 12/794,792

(22) Filed: Jun. 7, 2010

(30) Foreign Application Priority Data
Jun. 19, 2009 (GB) 0910663.4

(51) Int. Cl. G06G 7/48

(52) U.S. Cl. 703/10

(57) ABSTRACT

Method for providing reconciled estimates of three phase fluid flow for individual wells and at individual locations in a hydrocarbon production process facility comprising a plurality of wells.

### FIELD OF THE INVENTION

The present invention relates to multi phase flows. More specifically, the invention relates to a method for estimating three phase fluid flow for individual wells and at individual locations in a hydrocarbon production process facility comprising a plurality of wells.

### BACKGROUND OF THE INVENTION

Modern oil facilities consist of a single processing facility that is linked to a large number of production wells via multiphase flow lines. These facilities are highly instrumented, but the instruments are exposed to harsh conditions, they are difficult to access for maintenance, and they are sometimes inherently unreliable and inaccurate.

The owners and operators of a facility need to know the following:
Production rate at each well, and if this is consistent with the fiscal measurements.
If a value can be allocated from the fiscal measurements back to individual wells and fields.
If the multiphase flow meters in the well are working properly. If not, if it is possible to estimate the well flows using other measurements and a process model, and
if the sensors, located top-side and sub-sea, for measuring flow, pressure and temperature are accurate, or if they need calibration or repair.

The present invention describes a method and system for providing reconciled estimates of three phase flow comprising oil, gas and water production from individual wells in a complex, multi-reservoir field development using flow meters on wells and other flow and pressure measurements in the process. An object is to provide reconciled estimates of flow and pressure at all important points in the production facility, for individual wells, for individual pipes etc.

Since flow meters in wells can be inaccurate and may fail unexpectedly, it is required to check the sensors used, and provide reconciled estimates of flow when the sensors are faulty, i.e. do not provide any results, or give incorrect results.

Some prior art uses steady state models for individual wells and one or more steady state models of the process to estimate the flows for parts of the process. The simulation methods for the individual wells and the process are performed separately. The methods are then synchronized in an ad-hoc manner.

The behaviour of these processes is however dominated by dynamic effects, such as three-phase flow, environmental disturbances and operator intervention. Consequently, steady state models are not valid when the process is changing dynamically. In practice, use of steady state models means that well data is reconciled using only local information from a single well, well cluster or production area, and the overall estimates are generated using long-term, as for instance daily average production rates.

The state of the art for reconciling dynamic data requires either a recursive algorithm such as a Kalman Filter or the solution of a large-scale dynamic optimization problem. Both of these approaches are computationally not feasible given the complexity of the process to be represented.

The present invention builds on the well-established linkage of a dynamic process simulator and a multiphase simulator to simulate the behaviour of an entire processing facility. Kongsberg's present dynamic process simulator products are capable of embedding multiphase simulation tools to be able to simulate the linked flow-pressure behaviour of the wells, pipelines and the production facility. However, there is no rigorous or computationally-efficient way of using this model to calculate statistically correct reconciled estimates of flow and pressure. This is further described in the detailed description below with reference to FIG. 1.

The present invention introduces a novel method that makes the problem mentioned above practically feasible. The method is implemented in a system for overall flow metering, on-line modelling and process monitoring.

The benefits of this novel approach are:
The optimization problem is solved using information already available in the simulator;
The optimization problem is solved quickly, as the simulator runs. Repeated runs of the simulator over a time-period are not needed;
The system re-uses configuration information from design and training simulators. All that is needed of configuration is additional information about the expected accuracy of the measurements used in the calculations;
The method is capable of using any multiphase simulation tool that offers the type of interface described in the text below with reference to FIG. 1;
The method enables the delivery of a hitherto infeasible product, i.e. a system for reporting consistent, instantaneous reconciled production data throughout an oil and gas production facility.

### BRIEF DESCRIPTION OF THE DRAWINGS

The invention will now be described in more detail with reference to the drawings where:

FIG. 1 shows the principles for linking a multiphase simulator to a dynamic simulator, and

FIG. 2 shows the different steps comprised in the method for providing reconciled estimates of three phase fluid flows.

### DETAILED DESCRIPTION

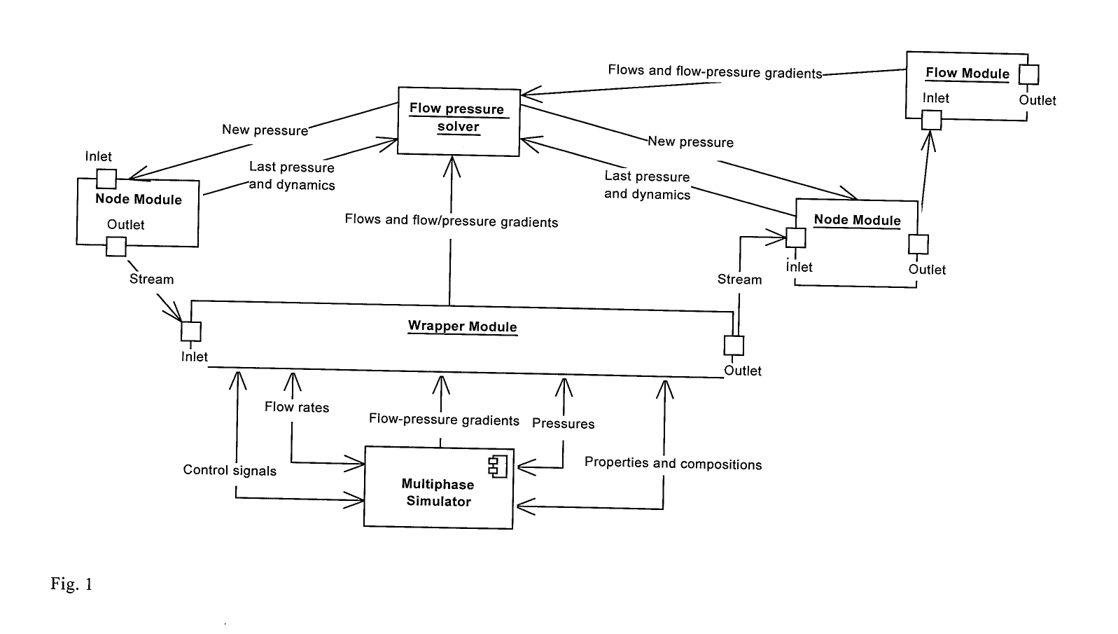

FIG. 1 shows the principles for linking the multiphase simulator to a dynamic simulator that are implemented in a variety of products in the market. Competitive advantage is obtained by the effectiveness of implementation rather than by the principles involved.

The dynamic simulator consists of several modules, i.e. software components that simulate the behaviour of a piece of process equipment. The flows of material between these modules are calculated as a function of system pressures as a system of algebraic non-linear equations. Each module in the simulator has different role in the flow pressure equations.

A “Wrapper Module” is used for interfacing the “Multiphase Simulator” to the dynamic process simulator.

The “Flow Pressure Solver” component in the simulator has responsibility for solving said non-linear equations using an iterative approach.

The “Node Modules” contain a material hold-up and are defined so that they set-up a discretized differential equation for the pressure in this piece of equipment.

The “Flow Module” set up equations for inlet and outlet flow—of each phase if desired—as a function of the pressures at either end. The inlet and outlet flow rates need not be the same.

The equations from all these modules, taken together, form the overall material balance for the system. These modules communicate with the flow pressure solver by setting the time-varying coefficients in these equations. The flow pressure solver then solves to obtain consistent flows and pressures throughout the system.

When flows or pressures at the boundary of the system are specified, this system of equations is square, with the same number of unknowns as equations. This allows the simulator to solve for all flows and pressures in the system at a given time.

As said, the multiphase simulator is embedded in the dynamic process simulator by interfacing it to the wrapper module. In its simplest form, the wrapper module maps its inlets and outlets to corresponding data structures in the multiphase simulator and behaves as a flow node, i.e. the flow pressure solver expects flow pressure gradients for each flow rate (input and output) in terms of the input and output pressures. These gradient values are obtained from the multivariable simulator as either analytically calculated values provided by the multiphase simulator or as numerically evaluated values determined by the wrapper module. The former approach is more accurate and efficient.

The simulator is usually built during the design of the facility and is then used for operator training. In all these cases, an engineer assumes the values of the boundary flows and pressures to the system. This enables the simulator to solve the dynamic behaviour of all the other flows and pressures in the system. In addition, embedded multiphase simulators can be connected so that they read process data and run in parallel with the process. This is done by assuming that the values of boundary pressures or flows are known exactly. This is however usually not the case.

During process operation, the process model can read values of pressure, total flow and phase flow at many points in the facility. These values are subject to measurement error and are usually inconsistent with each other and with the facility's material balance. The theoretical solution to this problem is well-known, i.e. choose boundary pressures and flows to minimize the weighted sum of squares of errors between the simulated values and corresponding measured values. This optimization problem is simple to formulate, but has hitherto been impossible to solve practically so that it can be incorporated in an overall flow metering system for the facility.

The method used is developed by analogy from a method published by Stephenson and Shewchuk (1986). They demonstrated how a system of algebraic equations formed by a simulation of a steady-state chemical process could be transformed using Lagrange multipliers into a larger system of algebraic equations that solves the data reconciliation problem for steady-state behaviour.

The inventive method applies and extends this approach to the system of algebraic equations that a dynamic flow-pressure solver solves when solving for flow and pressure at each time step in a dynamic simulation. These algebraic equations are obtained by discretizing the differential equations for pressure and flow Given that the network solver solves a system of equations:

f(p,m)=0 (1)

where p is a vector of pressures and m is a vector of flows, we measure a subset of the pressures, pₘ and flows mₘ. These two vectors set together are called uₘ. The corresponding elements in p and m are then pₑ and mₑ. These two vectors set together are called uₑ. The unmeasured elements of p and m are called pᵤ and mᵤ, and set together these vectors are called v.

The covariance matrix of measurements is denoted by Q and a matrix of weights (with elements only on the main diagonal) is called W. These matrices have the same number of rows and columns are there are elements in uₘ and uₑ.

At each time, step we then solve an optimization problem:

min g(u)=(uₘ−uₑ)^{T}W^{T}Q^{T}QW(uₘ−uₑ) (2)

subject to the constraints:

f(x)=f(p,m)=f(u_{e,}v)=0 (3)

Following Stephenson and Shewchuk, we use Lagrange multipliers to reformulate this problem as a system of non-linear equations. Forming the Lagrangian:

G(x,λ)=g(u)+λf(x) (4)

Differentiating with respect to the Lagrange multipliers, λ, and setting to zero we obtain:

$$\frac{\partial G}{\partial λ} = f ( x ) = 0 \qquad ( 5 )$$

which is our original set of algebraic equations.

For an optimal solution we also need to differentiate the Lagrangian with respect to x and solve for the value of x that gives a vector of zero derivatives.

$$\begin{matrix}\frac{\partial G}{\partial x} = [ \begin{matrix}A & 0 \\ 0 & 0\end{matrix} ] [ \begin{matrix}u \\ v\end{matrix} ] + {( \frac{\partial f}{\partial x} )}^{T} λ - [ \begin{matrix}B \\ 0\end{matrix} ] = 0 \\ where & ( 6 ) \\ A = 2 {W}^{T} {Q}^{T} QW \\ and & ( 7 ) \\ B = 2 {W}^{T} {Q}^{T} {QWu}_{m} & ( 8 )\end{matrix}$$

At each time-step, we then solve equations (5) and (6). The information necessary for these calculations is already calculated by the simulator and its existing flow-pressure solver algorithm.

This approach differs from the conventional methods of dynamic data reconciliation in the following ways:
(1) It differs from a an approach where a set of trajectories of variables is fitted by adjusting boundary conditions in that only information from a single time step is used in the calculation. This makes the approach computationally much more efficient than a naïve dynamic trajectory optimization.
(2) It differs from a Kalman filter—which is another single-step method—in two ways:
   a. The estimates are consistent with the process material balance. No such guarantee is possible with the Kalman filter.
   b. The accuracy of the model is not taken into account using a covariance matrix in this method. This is not considered to be a disadvantage, as the estimation of state covariance is difficult in practice.

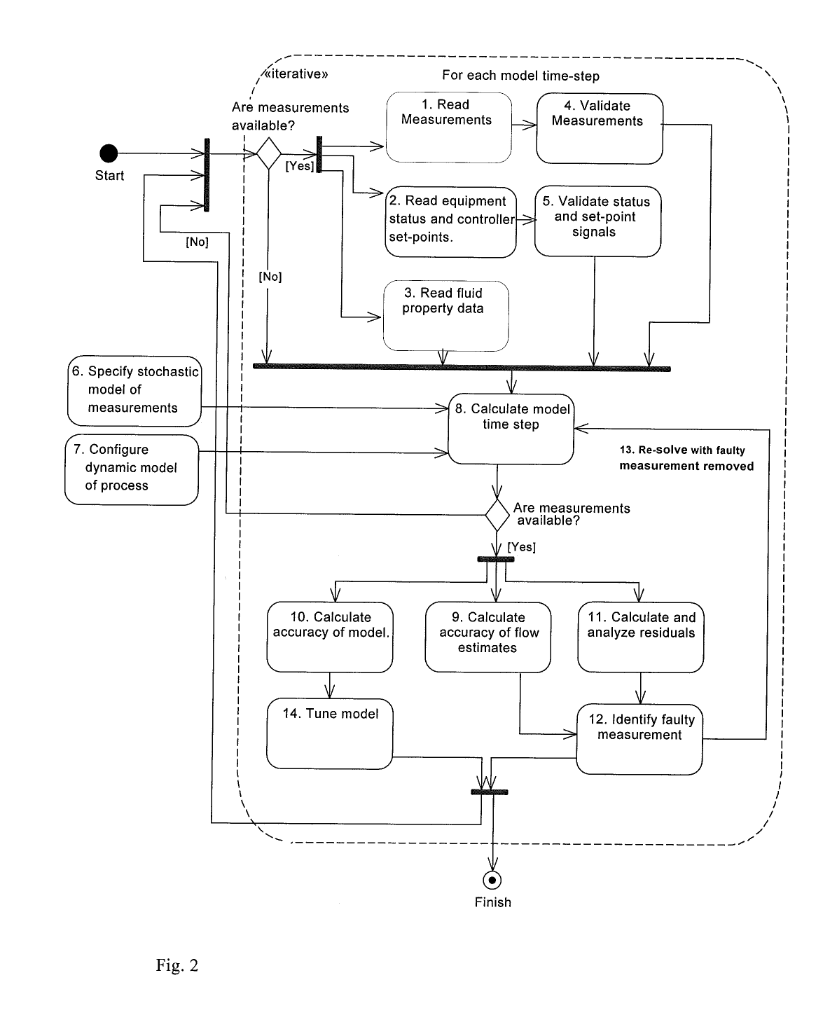

FIG. 2 shows the different steps comprised in the method for providing reconciled estimates of three phase fluid flow for individual wells and individual locations in a hydrocarbon production process facility with a plurality of wells.

The inventive method is realised in a system in which the simulator model communicates with an external system at a defined frequency.

At each execution time-step of the model, the simulator polls the source of data to determine whether new measurements are available. A time step may be in the range of once per second up to once per hour, depending on the availability of data and the dynamics of the process, although typical polling intervals are between once per minute and once every five minutes.

The first step in the method is to measure and read fluid data provided in the respective wells in the facility. Fluid data provided comprises several or all of the following measurement parameters: flow, phase composition, pressure, temperature and level. If new measurements are available, the simulator first reads the measurements 1. It also measure and reads the required equipment status signals and controller set points 2 in the hydrocarbon production process facility that are needed to track the system behaviour. These signals, that typically comprises valve position and driver speed, need to be validated using logical and mathematical tests for correctness 4, 5. In addition, any update in the properties or composition of the oil and gas flowing in the system needs to be read at this time 3.

The next step is to provide a stochastic model. During configuration of the system, an engineer has specified a stochastic model of the measurements 6, namely the covariance matrix Q, and weighting matrix W. These two matrices uniquely define the estimated accuracy of the measurements used in the calculation. These matrices may also be estimated and adjusted using observed process data.

A physics-based dynamic model of the process is provided and then configured 7. This model is assumed to be available, and can also be used for engineering studies, operator training and control system testing. The physics-based dynamic model is a typical simultaneous-modular dynamic simulator, as described above. This model is provided by graphically drawing the process flow sheet, with all relevant processing equipment, control equipment and pipelines represented by calculation modules. These modules are then connected together so that data that represents material flow and information flow can be passed between the modules. This configuration is done by an engineer using a graphical configuration editor. Configuration can also be done by directly editing structured text or XML data files. The modules used to build the model publish the variables and Jacobian matrix information that is needed to solve the material balance for the system. This is done without intervention by the engineer doing the configuration.

All the received information mentioned in the method steps above is sufficient to calculate the reconciled results for the simulator at the next time step 8 by calculating estimated fluid flow for the individual wells and locations based on consistency between the measured fluid data and process dynamic model.

The results of this calculation are then used to calculate the expected accuracy of the estimated fluid flow for the individual wells and locations 9. The expected accuracy of the dynamic model is also calculated 10. As is the residuals between estimated and measured values 11. These residuals are analysed to detect and identify faulty measurements 12 by calculating discrepancies between estimated fluid flows and measured fluid flows. Suspected faulty measurements can be excluded from the calculations 13, and the re-calculation for the specific time step is performed.

If the model is determined to be insufficiently accurate, other measurements can be used to manually or automatically tune the model 14. This can be done by choosing measurements that have a direct influence on one or more parameters in the model. An optimization algorithm or a Proportional Integral Derivative (PID) control algorithm is used to slowly adjust the parameters so that the residuals between the chosen measurements and the corresponding estimates from the model are minimized. It is important that this is done slowly—with time constants of hours or days—so that this tuning does not disturb the short term data reconciliation calculations. This process can be called separation of time scales.

The method steps described above will ensure that the reconciled production flows in the process facility is provided.

1. Method for providing reconciled estimates of a process with three phase fluid flow for individual wells and individual locations in a hydrocarbon production process facility with a plurality of wells, comprising the steps of:
a) measuring fluid data by sensors provided in the respective wells;
b) measuring fluid data and equipment data in the hydrocarbon production process facility;
c) providing a stochastic model for said measurements;
d) providing a physics-based dynamic model of the process;
e) configuring said physics-based model for supporting data reconciliation calculations;
f) calculating estimated fluid flow for the individual wells and locations based on consistency between the measured fluid data and the dynamic model of the process;
g) calculating expected accuracy of the estimated fluid flow for the individual wells and locations;
h) calculating expected accuracy of the dynamic model;
i) calculating discrepancies between the estimated fluid flow and the measured fluid flow.
j) using said calculated discrepancies to identify and correct faulty measurements and calculate the reconciled production flows in the process facility.

2. Method according to claim 1, where the fluid data measured comprises several or all of the following parameters: flow, phase composition, pressure, temperature, and level.

3. Method according to claim 1, where the equipment data comprises valve position and driver speed.

4. Method according to claim 1, where the physics-based dynamic model in step d) is provided by a simultaneous-modular dynamic simulator using a graphical configuration tool or by editing text or XML data files.

5. Method according to claim 1, where the configuring of said physics-based model for supporting data reconciliation calculations is performed by adding additional modules—reconciliation transmitters, data processing modules, statistical analysis modules and algorithm control modules to the previously configured dynamic model, and where this done using the same graphical configuration tool or by editing text or XML data files.
